(19) United States
(12) Patent Application Publication
(10) Pub. No.: US 2022/0131160 A1
(43) Pub. Date: Apr. 28, 2022

(54) ELECTRODE FOR METAL-AIR BATTERIES

(71) Applicant: RHEINISCHE-WESTFÄLISCHE TECHNISCHE HOCHSCHULE (RWTH) AACHEN, Aachen (DE)

(72) Inventors: Philipp Wunderlich, Aachen (DE); Ulrich Simon, Aachen (DE); Stefan Bajic, Aachen (DE); Jannis Kuepper, Aachen (DE)

(21) Appl. No.: 17/431,328

(22) PCT Filed: Dec. 17, 2019
(86) PCT No.: PCT/EP2019/085778

§ 371 Date: Aug. 16, 2021

(30) Foreign Application Priority Data
Feb. 15, 2019 (DE) 10 2019 103 937.1

(51) Int. Cl. H01M 4/96; H01M 12/06

(52) U.S. Cl. CPC H01M 4/96; H01M 2004/021; H01M 12/06

(57) ABSTRACT

The disclosure relates to a metal-air battery with dispersed carbon in the electrolyte solution.

### INTRODUCTION

The present disclosure relates to the field of batteries, especially metal-air batteries. These type of batteries have gained interest in recent years, metal-air batteries are a very interesting class of energy storage systems which—theoretically—could come close to the energy density of gasoline and reach specific energies of over 10,000 Wh/kg. In this type of batteries, typically lightweight metals like aluminum, zinc, magnesium or lithium are used as anode. Oxygen is used as cathode reactant. The use of oxygen is attractive because it is a sustainable, lightweight and low cost material.

However, there is a constant need for improved batteries of this type and therefore it is an object for the skilled person in the art to provide new and improved metal-air batteries and components therefore.

### SUMMARY

A metal-air-battery is provided, comprising a metal anode, a liquid electrolyte comprising a compound with the metal in cationic form, whereby the liquid electrolyte is accessible by air and/or oxygen, and a particulate carbon compound dispersed in said liquid electrolyte.

Surprisingly, it has been shown that for most applications within certain embodiments of the present disclosure one or more of the following advantages can be obtained:
The battery can be fabricated using unsophisticated equipment and with materials that are easily accessible
The battery shows a much higher capacity and specific energy as compared to previous batteries
Processing of the electrode-electrolyte dispersion eliminates drying or microstructure-forming steps.

The components of the battery according to some embodiments will be explained in more detail while all embodiments can be combined with other embodiments ad libitum:

### Metal

The battery comprises a metal anode, which may be (initially, before operation of the battery) formed out of a solid metal.

Preferably, per an embodiment, the metal is provided in form of a layer. Preferably, per an embodiment, the metal is provided as a foil with a thickness ranging between 30 μm and 1 mm.

Preferably, per an embodiment, the metal is selected from aluminum, zinc, magnesium lithium, sodium, calcium and alloys or intermetallic compounds thereof, with lithium especially preferred.

### Liquid Electrolyte

The battery comprises a liquid electrolyte. The term “liquid electrolyte” especially means and/or includes that the liquid electrolyte is either a solution (either aqueous or non-aqueous) of a salt or alternatively the liquid electrolyte may be an ionic liquid.

In case that a solution is used as liquid electrolyte, it is preferred, per an embodiment, that the liquid electrolyte comprises a salt comprising a weakly coordinating anion and a metal cation. Preferred weakly coordinating, per an embodiment, comprise tetrafluorborates, hexafluorphosphates, chlorates, organic tetraborates such as tetraphenylborates, especially tetrakis(3,5-bis(trifluoromethyl)phenyl)borate, nitrates, bis(trifluoromethanesulfonyl)imides.

Suitable solvents, per an embodiment, are selected out of water, DMSO, ionic liquids, ethers and polyethers, especially dimethoxy ethane and tetraethylene glycol dimethyl ether, and carbonates and polycarbonates.

In case that non-aqueous solvents are used, it is preferred, per an embodiment, that the solvents are water-free. Alternatively, in case that non-aqueous solvents are used, it is preferred, per an embodiment, that the solvents contain water in (vol/vol of the total solvent) from >0 to ≤1%, preferably ≤0.5%.

In case that the liquid electrolyte comprises or consists essentially of an ionic liquid then sulfonimides, especially Bis(trifluoromethane)sulfonimides are preferred per an embodiment.

The term “consisting essentially of” and/or “essentially” in the context of this disclosure especially means a content (in wt/wt) of ≥90%, especially ≥95%, more preferred ≥98% and most preferred ≥99%.

The term “having essentially” in the context of this disclosure especially means a content (in number/total number) of ≥90%, especially ≥95%, more preferred ≥98% and most preferred ≥99%.

### Carbon Compound

The battery comprises, per an embodiment, a particulate carbon compound dispersed in said liquid electrolyte.

The term “particulate” especially means and/or includes that the particulate carbon compound comprises, more preferred consists essentially of particles whereby the average diameter in the longest direction of the particles is ≤1000 μm, preferably ≤200 μm most preferred ≤100 μm.

Preferred the D50 (in the longest direction) of the particulate carbon compound, per an embodiment, is ≤500 μm, preferably ≤200 μm, most preferred ≤100 μm.

According to an embodiment of the present disclosure, the particulate carbon compound comprises a nanoparticulate carbon compound, especially it contains essentially of a particulate carbon compound. The term “nanoparticulate” especially means and/or includes that the particulate carbon compound comprises, more preferred consists essentially of particles whereby the average diameter in the longest direction of the particles is ≤100 nm, preferably ≤50 nm, most preferred ≤10 nm.

Preferred the D50 (in the longest direction) of the nanoparticulate carbon compound, per an embodiment, is ≤100 nm, preferably ≤50 nm, most preferred ≤10 nm.

The term “carbon compound” in the sense of the present disclosure especially means a compound which consists essentially of carbon, with graphite especially preferred.

According to an embodiment of the present disclosure, the particulate carbon compound comprises, preferably consists essentially of carbon nanotubes, carbon nano walls, carbon blacks (known in the art e.g. as Super P, Ketjen Black), mesoporous carbon, graphene and graphite or mixtures thereof with graphite especially preferred.

According to an embodiment of the present disclosure, the particulate carbon compound comprises, preferably consists essentially of nanosheets. This has shown to be advantageous, per some embodiment, for many applications within the present disclosure. Surprisingly, the inventors have for many applications within embodiments of the disclosure found out that such sheets do not stack to form inactive larger agglomerates and their surface remains fully active.

The term “nanosheets” especially means/and or includes a sheet-like structure whereby average length and width of the sheets is ≥100 nm and ≤100 μm and the average height of the sheets is ≥0.5 nm and ≤50 nm, especially ≥1 nm and ≤10 nm.

According to an embodiment of the disclosure, the BET of the particulate carbon compound is from ≥1 m²/g and ≤3000 m²/g. The BET can be measured using the DIN ISO 9277.

The term “dispersed” especially means and/or includes a fine homogeneous distribution of the particulate carbon in the liquid electrolyte.

The content of carbon compound within the electrolyte liquid (in g/l) is preferably ≥5 g/l and ≤500 g/l, more preferred ≥20 g/l and ≤400 g/l and most preferred ≥40 g/l and ≤80 g/l.

According to an embodiment of the disclosure, the battery comprises a foam and/or sponge-like material whereby at least part of the liquid electrolyte and/or the particulate carbon material are present inside and/or with the pores, openings and/or recesses of the foam and/or sponge-like material.

This has been shown to be advantageous for many applications within certain embodiments of the present disclosure as it helps to achieve a greater distribution of the particulate carbon material.

The term “foam and/or sponge-like material” especially means and includes a material capable of containing particles or liquids in its open-porous structure.

According to an embodiment of the present disclosure, the foam and/or sponge-like material is essentially inactive. The term “essentially inactive” in the context of the present disclosure especially means/and or includes a material that itself does not participate in the electrochemical reactions to significantly contribute to the capacity of the battery.

According to an embodiment of the disclosure, the foam and/or sponge-like material comprises pores, openings and/or recesses with a diameter of ≥10 μm and ≤1 mm, preferably all the pores, openings and/or recesses have essentially this diameter.

Preferably, per an embodiment, the porosity of the foam and/or sponge-like material is ≥98%, more preferred ≥99%.

Preferably, per an embodiment, the density of the foam and/or sponge-like material is ≥5 mg/cm² and ≤20 mg/cm², most preferred is ≥8 mg/cm² and ≤12 mg/cm².

According to an embodiment of the disclosure, the foam and/or sponge-like-material comprises, preferably consists essentially out of a material selected from the group melamine foam, polyurea foam, polyurethane foam, metal foams, especially nickel foams, or mixtures thereof.

According to an embodiment of the disclosure, the carbon compound that is dispersed in the liquid electrolyte is essentially immobilized in the foam and/or sponge-like material.

The term “immobilized” in the context of this disclosure especially means/and includes that while the battery is in operation, the respective compound is essentially contained and/or held and/or present in the pores, openings and/or recesses of the foam and/or sponge-like material.

Additionally and/or alternatively according to an embodiment of the disclosure, the part of the liquid electrolyte which contains the carbon compound is essentially immobilized in the foam and/or sponge-like material.

The aforementioned components, as well as the claimed components and the components to be used in accordance with the disclosure in the described embodiments, are not subject to any special exceptions with respect to their size, shape, material selection and technical concept such that the selection criteria known in the pertinent field can be applied without limitations.

Additional details, characteristics and advantages of the object of certain embodiments of the disclosure are disclosed in the subclaims and the following description of the respective figures—which in an exemplary fashion—show embodiments according to the disclosure. Such embodiment does not necessarily represent the full scope of the disclosure, however, and reference is made therefore to the claims and herein for interpreting the scope of the disclosure. It is to be understood that both the foregoing general description and the following detailed description are exemplary and explanatory only and are intended to provide further explanation of the present disclosure as claimed.

### BRIEF DESCRIPTION OF THE FIGURES

FIG. 1 shows a diagram showing the discharge curves V (Q) for two batteries according to the examples I and II of certain embodiments of the present disclosure;

FIG. 2 shows a scanning electron microscopy images (SEM) of the electrode of example I; and

FIG. 3 shows a scanning electron microscopy image (SEM) of the electrode-electrolyte dispersion according to example II.

### DETAILED DESCRIPTION

The following disclosure will be described using the following examples which are illustrative only and non-binding:

### General Preparation Methods

Lithium-oxygen batteries were assembled in an argon-filled glovebox by stacking a lithium foil anode (d=18 mm, t=300 μm), a ceramic sheet separator (d=20 mm) and a positive electrode in a battery test cell. Two types of positive electrodes were investigated:

### Example I: GNS-Loaded Foams

Melamine foam blocks (obtained from dm Drogeriemarkt) were cut into disks (d=18 mm, t=1.5 mm) using a custom-made tool. A gold-layer was coated onto the polymer disks via DC sputtering (P 100 W, t=155 s, pAr=10-2 mbar) in order to create a conductive current-collector substrate. The substrates (m=5 mg±2 mg) were dipped into a mixture of 40 mg graphite nanosheets (GNS) in 1 mL isopropanol, sonicated for 10 minutes, taken out of the mixture and dried at 100° C. overnight. When added to the cell stack, the this all-solid-state electrode was wetted with 100 μL electrolyte solution (1.0 M Lithium bis(trifluoro-methanesulfonyl)imide, LiTFSI, in tetraethylene glycol dimethyl ether, TEGDME).

### Example II: GNS-Electrolyte Dispersions

A dispersion of 40 mg GNS in 500 μL 1.0M LiTFSI in TEGDME was prepared in an argon-filled glovebox and a current collector disk (same as in the section above) was dip-coated with the carbon-electrolyte slurry. The whole electrode-electrolyte assembly was added to the cell stack without any further drying or addition of electrolyte.

Cells were sealed, removed from the glovebox and connected to oxygen lines where an oxygen pressure of 3 bar (above atmosphere) was applied. After a resting step of 6 h, batteries galvanostatically discharged at 150 μA/cm² until the cell potential dropped below 2.0 V.

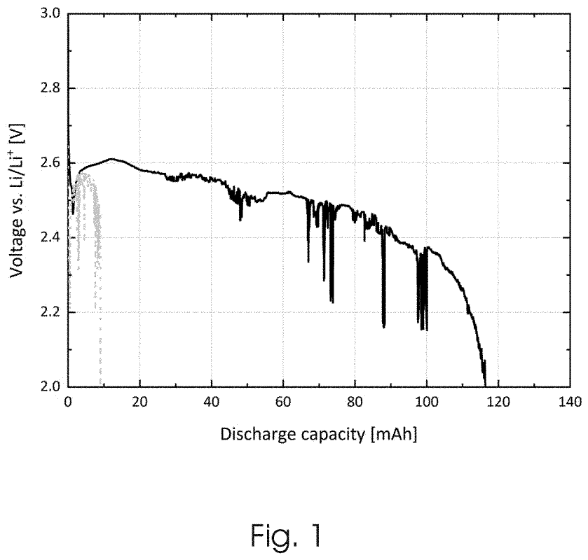

FIG. 1 shows the discharge curves V(Q) for lithium-oxygen batteries using the electrode of example I (dotted line, Q=8.98 mAh) and the electrode of example II (ii) (straight line, Q=116.35 mAh).

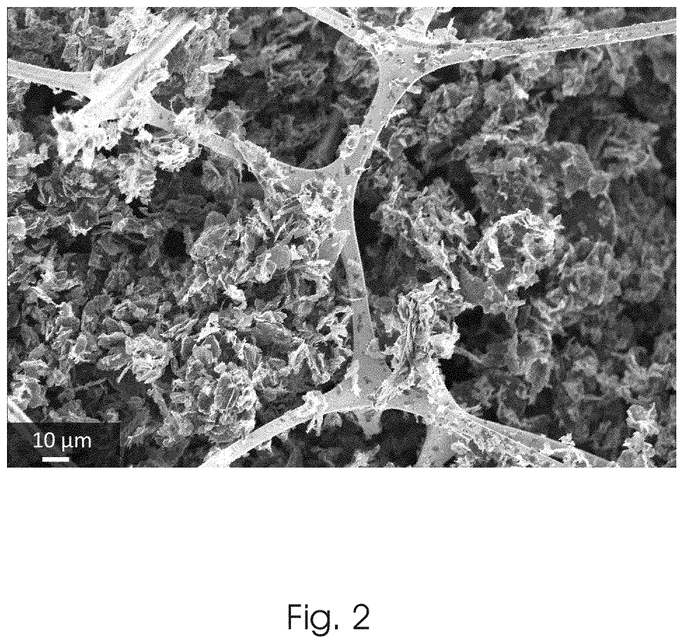

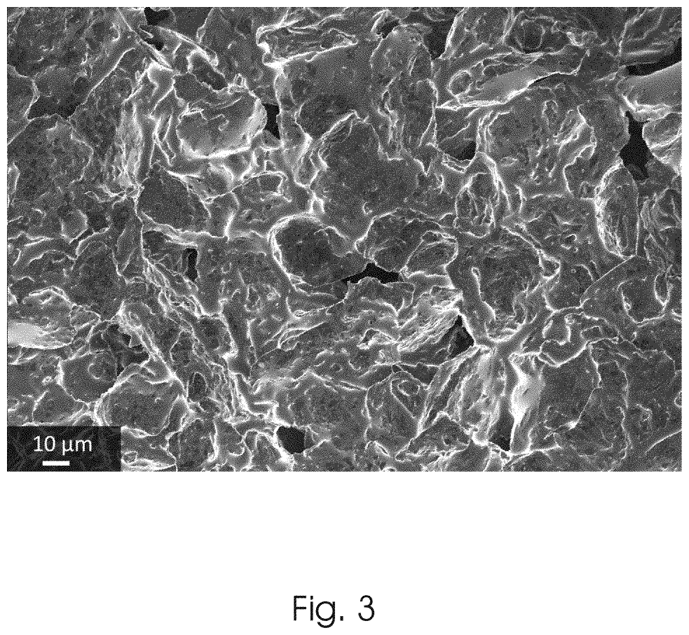

FIGS. 2 and 3 show scanning electron microscopy images (SEM) of the electrode of Example I and II, respectively.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the disclosure as claimed. Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The invention's scope is defined in the following claims and the equivalents thereto. Furthermore, reference signs used in the description and claims do not limit the scope of the invention as claimed.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A metal-air-battery, comprising a metal anode, a liquid electrolyte comprising a compound with the metal in cationic form, wherein the liquid electrolyte is accessible by air and/or oxygen, and a particulate carbon compound dispersed in the liquid electrolyte.

2. The battery of claim 1, wherein the particulate carbon compound comprises particles, wherein the average diameter in a longest direction of the particles is ≤1000 μm

3. The battery of claim 1, wherein a D₅₀ (in the longest direction) of the particulate carbon compound is ≤500 μm.

4. The battery of claim 1, wherein the particulate carbon compound comprises graphite.

5. The battery of claim 1, wherein the particulate carbon compound comprises nanosheets.

6. The battery of claim 1, wherein the BET of the particulate carbon compound is from ≥1 m²/g and ≤3000 m²/g.

7. The battery of claim 1, wherein the content of carbon compound within the liquid electrolyte (in g/l) is ≥5 g/l and ≤500 g/l.

8. The battery of claim 1, comprising a foam and/or sponge-like material, wherein at least part of the liquid electrolyte and/or the particulate carbon material are present inside and/or with the pores, openings and/or recesses of the foam and/or sponge-like-material.

9. The battery of claim 8, wherein the foam and/or sponge-like material is essentially inactive.

10. The battery of claim 8, wherein the carbon compound that is dispersed in the liquid electrolyte is essentially immobilized in the foam and/or sponge-like material

11. The battery of claim 8, wherein the part of the liquid electrolyte which contains the carbon compound is essentially immobilized in the foam and/or sponge-like material

12. The battery of claim 8, wherein the foam and/or sponge-like-material comprises a material selected from the group melamine foam, polyurea foam, polyurethane foam, metal foams, especially nickel foams, or mixtures thereof.

13. The battery of claim 8, wherein the density of the foam and/or sponge-like material is ≥5 mg/cm² and ≤20 mg/cm².
